(19) United States
(12) Patent Application Publication
(10) Pub. No.: US 2010/0169157 A1
(43) Pub. Date: Jul. 1, 2010

(54) METHODS, APPARATUSES, AND COMPUTER PROGRAM PRODUCTS FOR PROVIDING TARGETED ADVERTISING

(75) Inventors: Ahti Muhonen, Hirvihaara (FI); Jari Takala, Espoo (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/346,424

(22) Filed: Dec. 30, 2008

(51) Int. Cl. G06Q 30/00; G06Q 10/00

(52) U.S. Cl. 705/10; 705/14.43; 705/14.66

(57) ABSTRACT

A method, apparatus, and computer program product are provided for providing targeted advertising. An apparatus may include a processor configured to generate a targeting vector and provide the targeting vector to an advertising platform to permit one or more advertisements to be selected based at least in part upon the provided targeting vector. The processor may be further configured to receive the one or more advertisements from the advertising platform. The processor may additionally be configured to monitor a user's interaction with the received advertisements to determine an effectiveness level of the advertisements. The processor may be further configured to update the targeting vector when the determined effectiveness level is less than a target effectiveness level by modifying the targeting vector to enhance the effectiveness level of advertisements selected based at least in part upon the targeting vector. Corresponding methods and computer program products are also provided.

### TECHNOLOGICAL FIELD

Embodiments of the present invention relate generally to communication technology and, more particularly, relate to methods, apparatuses, and computer program products for providing targeted advertising.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies as well as evolved computing devices making use of networking technologies continue to facilitate ease of information transfer and convenience to users. Evolved networking technologies and computing devices facilitate accessing a wide array of content from remote content providers for consumption at a user's local computing device. Often, the costs to content providers of providing content to remote users over a network are defrayed through advertisers paying to have advertising included with the provided content.

For this advertising to have the most value to advertisers and thus to enable content providers to charge a premium value for advertising space, the advertisements need to attract the interest of users that are provided with the advertisements so as to induce users to purchase advertised products and services. Accordingly, advertisers attempt to “target” advertisements to specific users.

Today, targeting is often performed as a background process occurring in the server-side of an advertising platform. However, this targeting is often problematic. In some cases, a user accessing content may be unidentified and thus there may not be sufficient information about the user available to the advertising platform and/or content provider to target appropriate advertising to the particular user. In other instances, there may be privacy issues related to collecting and aggregating user data for use in targeting advertising at a server. Further, existing methods of targeting advertisements may not make full use of available data to adjust the targeting over time as more information about a user and the user's interactions with previous advertising is learned.

Accordingly, it would be advantageous to provide methods, apparatuses, and computer program products for providing targeted advertising, which may address at least some of the above-described deficiencies of existing targeting techniques.

### BRIEF SUMMARY OF SOME EXAMPLES OF THE INVENTION

A method, apparatus, and computer program product are therefore provided for providing targeted advertising. In this regard, a method, apparatus, and computer program product are provided that may provide several advantages to advertisers, content providers, and computing device users. Embodiments of the invention provide enhanced targeted advertising such that a targeting vector used to select advertisements to present to a user is periodically updated based on a feedback loop as more data about the user's behavior and interactions with previously presented advertisements is collected. Embodiments of the invention locally collect data and generate the targeting vector such that targeted advertising may be provided to a user by an advertising server even if the user is not previously known to the advertising server. Further, by locally collecting the user data and generating the targeting vector, users may benefit from reduced risk of sensitive data being compromised.

In a first exemplary embodiment, an apparatus is provided, which may include a processor configured to determine one or more user parameters. Each user parameter may define an attribute of a user of the apparatus. The processor may be configured to determine each user parameter based at least in part upon locally collected user data. The processor may be further configured to generate a targeting vector based at least in part upon the one or more determined user parameters. The processor may additionally be configured to provide the targeting vector to an advertising platform to permit one or more advertisements to be selected based at least in part upon the provided targeting vector. The processor may be further configured to receive the one or more advertisements from the advertising platform. The processor may also be configured to present the one or more received advertisements to the user. The processor may additionally be configured to monitor the user's interaction with the received one or more advertisements to determine an effectiveness level of the one or more received advertisements. The processor may be further configured to update the targeting vector when the determined effectiveness level is less than a target effectiveness level by modifying the targeting vector to enhance the effectiveness level of advertisements selected based at least in part upon the targeting vector. The processor may additionally be configured to provide the updated targeting vector to the advertising platform to permit future received advertisements to be selected based at least in part upon the updated targeting vector.

In another exemplary embodiment, a method is provided, which may include determining one or more user parameters. Each user parameter may define an attribute of a user of the apparatus. The method may further include generating a targeting vector based at least in part upon the one or more determined user parameters. The method may additionally include providing the targeting vector to an advertising platform to permit one or more advertisements to be selected based at least in part upon the provided targeting vector. The method may further include receiving the one or more advertisements from the advertising platform. The method may also include presenting the one or more received advertisements to the user. The method may additionally include monitoring the user's interaction with the received one or more advertisements to determine an effectiveness level of the one or more received advertisements. The method may further include updating the targeting vector when the determined effectiveness level is less than a target effectiveness level by modifying the targeting vector to enhance the effectiveness level of advertisements selected based at least in part upon the targeting vector. The method may additionally include providing the updated targeting vector to the advertising platform to permit future received advertisements to be selected based at least in part upon the updated targeting vector.

In another exemplary embodiment, a computer program product is provided. The computer program product includes at least one computer-readable storage medium having computer-readable program instructions stored therein. The computer-readable program instructions may include a plurality of program instructions. Although in this summary, the program instructions are ordered, it will be appreciated that this summary is provided merely for purposes of example and the ordering is merely to facilitate summarizing the computer program product. The example ordering in no way limits the implementation of the associated computer program instructions. The first program instruction is for determining one or more user parameters. Each user parameter may define an attribute of a user of the apparatus. The second program instruction is for generating a targeting vector based at least in part upon the one or more determined user parameters. The third program instruction is for providing the targeting vector to an advertising platform to permit one or more advertisements to be selected based at least in part upon the provided targeting vector. The fourth program instruction is for receiving the one or more advertisements from the advertising platform. The fifth program instruction is for presenting the one or more received advertisements to the user. The sixth program instruction is for monitoring the user's interaction with the received one or more advertisements to determine an effectiveness level of the one or more received advertisements. The seventh program instruction is for updating the targeting vector when the determined effectiveness level is less than a target effectiveness level by modifying the targeting vector to enhance the effectiveness level of advertisements selected based at least in part upon the targeting vector. The eighth program instruction is for providing the updated targeting vector to the advertising platform to permit future received advertisements to be selected based at least in part upon the updated targeting vector.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for providing targeted advertising according to an exemplary embodiment of the present invention;

FIG. 2 is a schematic block diagram of a mobile terminal according to an exemplary embodiment of the present invention; and

FIG. 3 is a flowchart according to an exemplary method for providing targeted advertising according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

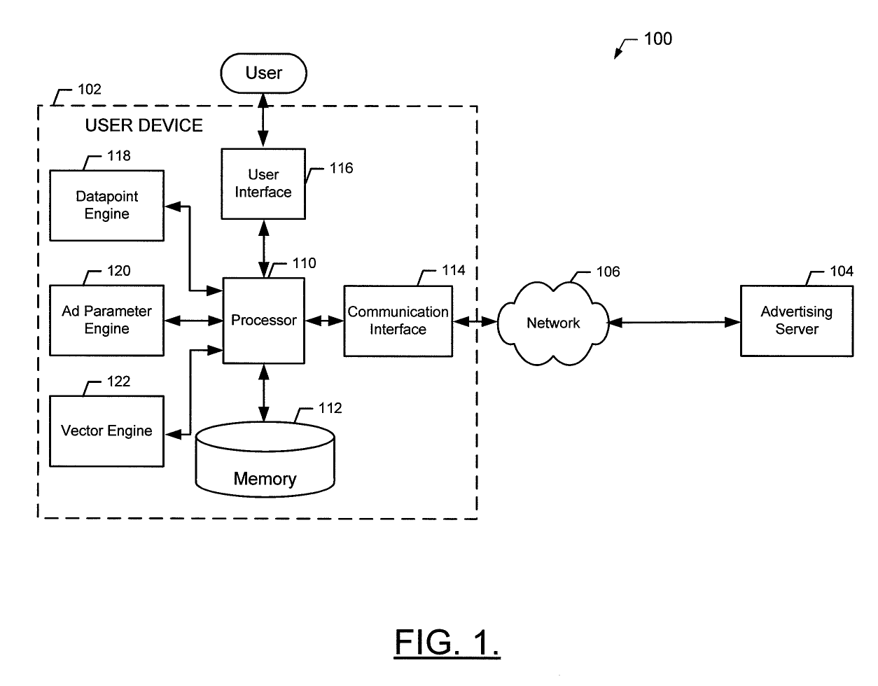

FIG. 1 illustrates a block diagram of a system 100 for providing targeted advertising according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for providing targeted advertising, numerous other configurations may also be used to implement embodiments of the present invention.

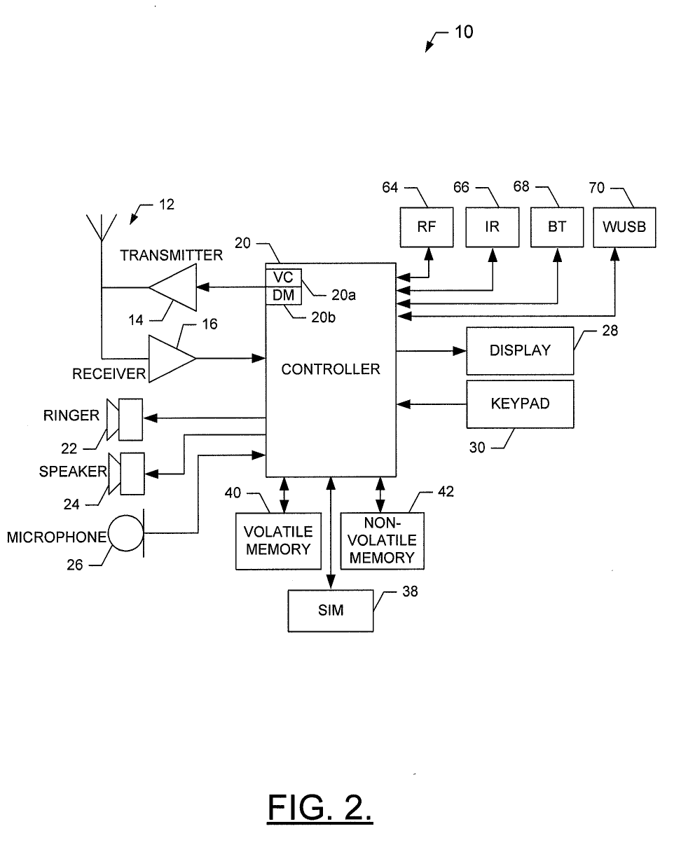

In at least some embodiments, the system 100 includes a user device 102 and advertising server 104 configured to communicate over the network 106. The advertising server 104 may be embodied as any computing device or plurality of computing devices configured to provide advertisements to the user device 102. Although only a single advertising server 104 is illustrated in FIG. 1, the system 100 may comprise a plurality of advertising servers 104. The network 106 may be embodied as any wireless network (e.g., a cellular network), wireline network, or combination thereof. In at least some embodiments, the network 106 comprises or is otherwise embodied as the Internet. The user device 102 may be embodied as a desktop computer, laptop computer, mobile terminal, mobile computer, mobile phone, mobile communication device, game device, digital camera/camcorder, audio/video player, television device, radio receiver, digital video recorder, positioning device, any combination thereof, and/or the like that is configured to present an advertisement to a user of the user device 102 in accordance with an embodiment of the invention described herein. Although only a single user device 102 is illustrated in FIG. 1, the system 100 may comprise a plurality of user devices 102, which may receive advertisements and/or advertising campaigns from the advertising server 104. In an exemplary embodiment, the user device 102 is embodied as a mobile terminal, such as that illustrated in FIG. 2.

In this regard, FIG. 2 illustrates a block diagram of a mobile terminal 10 representative of one embodiment of a user device 102 in accordance with embodiments of the present invention. It should be understood, however, that the mobile terminal 10 illustrated and hereinafter described is merely illustrative of one type of user device 102 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal may also include a controller 20 or other processor(s) that provides signals to and receives signals from the transmitter and receiver, respectively. These signals may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) or WiMAX protocols.

It is understood that the controller 20 may comprise circuitry for implementing audio/video and logic functions of the mobile terminal 10. For example, the controller 20 may comprise a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the controller 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

The mobile terminal 10 may include a positioning sensor (not shown.) The positioning sensor may include, for example, a global positioning system (GPS) sensor, an assisted global positioning system (Assisted-GPS) sensor, etc. In one embodiment, however, the positioning sensor may include a pedometer or inertial sensor. In some embodiments, the positioning sensor is additionally or alternatively configured to determine a location of the mobile terminal using short-range radio signals, such as, for example, WLAN signals, Blue Tooth signals, and/or the like. Further, the positioning sensor may determine the location of the mobile terminal based upon signal triangulation or other mechanisms. The positioning sensor may be configured to determine a location of the mobile terminal, such as latitude and longitude coordinates of the mobile terminal or a position relative to a reference point such as a destination or a start point. Information from the positioning sensor may be communicated to a memory of the mobile terminal or to another memory device to be stored as a position history or location information. Furthermore, a memory of the mobile terminal may store instructions for determining cell id information. In this regard, the memory may store an application program for execution by the controller 20, which may determine an identity of the current cell, i.e., cell id identity or cell id information, with which the mobile terminal is in communication. In conjunction with the positioning sensor, the cell id information may be configured to more accurately determine a location of the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an exemplary embodiment, the user device 102 includes various means, such as a processor 110, memory 112, communication interface 114, user interface 116, datapoint engine 118, ad parameter engine 120, and vector engine 122 for performing the various functions herein described. Although only a single datapoint engine 118 and a single ad parameter engine 120 are illustrated in FIG. 1, the user device 102 may comprise a plurality of datapoint engines 118 and/or ad parameter engines 120. These means of the user device 102 as described herein may be embodied as, for example, hardware elements (e.g., a suitably programmed processor, combinational logic circuit, and/or the like), computer code (e.g., software or firmware) embodied on a computer-readable medium (e.g. memory 112) that is executable by a suitably configured processing device (e.g., the processor 110), or some combination thereof. The processor 110 may, for example, be embodied as various means including a microprocessor, a coprocessor, a controller, or various other processing elements including integrated circuits such as, for example, an ASIC (application specific integrated circuit) or FPGA (field programmable gate array). In embodiments wherein the user device 102 is embodied as a mobile terminal 10, the processor 110 may be embodied as or otherwise comprise the controller 20. In an exemplary embodiment, the processor 110 is configured to execute instructions stored in the memory 112 or otherwise accessible to the processor 110. Although illustrated in FIG. 1 as a single processor, in some embodiments the processor 110 comprises a plurality of processors.

The memory 112 may include, for example, volatile and/or non-volatile memory. The memory 112 may be configured to store information, data, applications, instructions, or the like for enabling the user device 102 to carry out various functions in accordance with exemplary embodiments of the present invention. For example, in at least some embodiments, the memory 112 is configured to buffer input data for processing by the processor 110. Additionally or alternatively, in at least some embodiments, the memory 112 is configured to store program instructions for execution by the processor 110. The memory 112 may comprise one or more databases that store information in the form of static and/or dynamic information. This stored information may be stored and/or used by the datapoint engine 118, ad parameter engine 120 and/or vector engine 122 during the course of performing their functionalities.

The communication interface 114 may be embodied as any device or means embodied in hardware, software, firmware, or a combination thereof that is configured to receive and/or transmit data from/to a remote device, such as the advertising server 104 over the network 106. In at least one embodiment, the communication interface 114 is at least partially embodied as or otherwise controlled by the processor 110. The communication interface 114 may include, for example, an antenna, a transmitter, a receiver, a transceiver and/or supporting hardware or software for enabling communications with other entities of the system 100. The communication interface 114 may be configured to receive and/or transmit data using any protocol that may be used for communications between computing devices of the system 100. The communication interface 114 may additionally be in communication with the memory 112, datapoint engine 118, ad parameter engine 120, and/or vector engine 122, such as via a bus.

The user interface 116 may be in communication with the processor 110 to receive an indication of a user input and/or to provide an audible, visual, mechanical, or other output to the user. As such, the user interface 116 may include, for example, a keyboard, a mouse, a joystick, a display, a touch screen display, a microphone, a speaker, and/or other input/output mechanisms. The user interface 116 may accordingly provide means present an advertisement to a user, such as through display of an advertisement on a display. The user interface 116 may be in communication with the memory 112, communication interface 114, datapoint engine 118, ad parameter engine 120, and/or vector engine 122, such as via a bus.

Each datapoint engine 118 may be embodied as various means, such as hardware, software, firmware, or some combination thereof and, in one embodiment, is embodied as or otherwise controlled by the processor 110. In embodiments where a datapoint engine 118 is embodied separately from the processor 110, the datapoint engine 118 may be in communication with the processor 110. As previously mentioned, the user device 102 may comprise a plurality of datapoint engines 118, each configured to collect and aggregate a unique category of data. Alternatively, the user device 102 may comprise a single datapoint engine 102 configured to collect and aggregate multiple unique categories of data. Accordingly, for purposes of discussion herein, when the datapoint engine 118 is referred to, it is to be construed as including both embodiments with multiple datapoint engines 118 and embodiments with a single datapoint engine 118. The datapoint engine 118 may further be in communication with the memory 112, communication interface 114, user interface 116, ad parameter engine 120, and/or vector engine 122, such as via a bus.

Each ad parameter engine 120 may be embodied as various means, such as hardware, software, firmware, or some combination thereof and, in one embodiment, is embodied as or otherwise controlled by the processor 110. In embodiments an ad parameter engine 120 is embodied separately from the processor 110, the ad parameter engine 120 may be in communication with the processor 110. As previously mentioned, the user device 102 may comprise a plurality of ad parameter engines 120, each configured to determine a particular user parameter. Alternatively, the user device 102 may comprise a single ad parameter engine 120 configured to determine multiple user parameters. Accordingly, for purposes of discussion herein, when the ad parameter engine 120 is referred to, it is to be construed as including both embodiments with multiple ad parameter engines 120 and embodiments with a single ad parameter engine 120. The ad parameter engine 120 may further be in communication with the memory 112, communication interface 114, user interface 116, datapoint engine 118, and/or vector engine 122, such as via a bus.

The vector engine 122 may be embodied as various means, such as hardware, software, firmware, or some combination thereof and, in one embodiment, is embodied as or otherwise controlled by the processor 110. In embodiments where the vector engine 122 is embodied separately from the processor 110, the vector engine 122 may be in communication with the processor 110. The vector engine 122 may further be in communication with the memory 112, communication interface 114, user interface 116, datapoint engine 118, and/or ad parameter engine 120, such as via a bus.

In at least some embodiments, the datapoint engine 118 is configured to collect raw data related to a user's usage of the user device 102 from different incidents and user events and store the collected data in a memory, such as the memory 112. These incidents and user events may comprise, for example, Bluetooth usage, application usage, a start of a phone call, end of a phone call, length of a phone call, the other party to the phone call, sending of a message (e.g., a text message, multimedia message, email message, instant message, and/or the like), receipt of a message, the other party to a sent or received message, a web page visited by a user of the user device 102, content downloaded to the user device 102 by the user from a remote computing device, content uploaded from the user device 102 to a remote computing device by the user, a location visited by the user (e.g., determined by a positioning sensor in embodiments wherein the user device 102 is a mobile computing device, such as a mobile terminal 10) and/or the like. Accordingly, the datapoint engine 118 may be configured to collect user data by observing actions taken by the user in interacting with or otherwise using the user device 102.

The datapoint engine 118 is further configured in at least some embodiments to aggregate the collected usage data into one or more categories of collected data (e.g., call history data, messaging data, web browsing data, and/or the like).The datapoint engine 118 may further analyze each category of collected data to determine a user profile data point for each category of data. These user profile data points may include, for example, a description of the user's usage habits (e.g., a description of how often the user engages in certain activities using the device). Examples of such a user profile data points may comprise, for example, “frequent Bluetooth user,” “frequently visits sports-related websites,” “frequently shops online for clothing,” “rarely visits news-related websites,” “downloads music frequently,” and/or the like.

The user profile data points may additionally or alternatively comprise information about a target consumer of the user device 102, which may be specified by the manufacturer of the user device 102. In this regard, some user devices may include fewer features so that they may be marketed at a lower cost and targeted at individuals with less disposable income. Other user devices may include several extra features tailored for use by business professionals or some other category of users and thus may be marketed at a higher cost and/or targeted toward a particular user group. Accordingly, the datapoint engine 118 is configured in some embodiments to determine user profile data points based at least in part upon properties of the user device 102.

In at least some embodiments, the ad parameter engine 120 is configured to determine one or more user parameters based at least in part upon data collected by the datapoint engine 118. In this regard, the ad parameter engine 120 may be configured to determine each user parameter based at least in part upon one or more profile data points determined by the datapoint engine 118. Each user parameter defines an attribute of a user that may be used by the vector engine 122 to generate a targeting vector and/or intermediate targeting vector. For example, the user parameters may comprise values describing, for example, the user's gender, age, income level, location, and/or other parameters describing the user of the user device 102. In this regard, the ad parameter engine 120 may be configured to analyze user profile data points and/or other data collected by the datapoint engine 118, determine what data is useful in determining a user parameter through statistical analysis and determine an answer for each user parameter. This answer may comprise a discrete answer (e.g., gender=male, age=32, location=New York, and/or the like) and/or a range of values (e.g., annual income=$40,000-$60,000, age=21-25, and/or the like). The ad parameter engine 120 may be configured to store the determined user parameters in the memory 112 and/or to provide the determined user parameters to the vector engine 122.

The vector engine 122 is configured to access user parameters determined by the ad parameter engine 120 and generate a targeting vector based at least in part upon one or more of the user parameters. In this regard, a targeting vector comprises a vector of data describing the user that may be used to select advertisements to provide to the user such that the selected advertisements may be of interest to the user. For example, the ad parameter engine may determine the user parameters “X₁,” “Y₁,” and “Z₁”. Accordingly, the vector engine may generate the vector (X₁, Y₁, Z₁) based on those user parameters.

In some embodiments, this generated targeting vector may comprise a final targeting vector that the vector engine 122 provides to an advertising platform to be used by the advertising platform to select one or more individual advertisements and/or an advertising campaign comprising one or more advertisements to send to the user device 102. In some embodiments, however, this generated targeting vector may comprise an intermediate targeting vector and the vector engine 122 may be configured to receive one or more additional intermediate targeting vectors (e.g., the vector (X₂, Y₂, Z₂)) from other sources, such as from the advertising server 104. These additional targeting vectors may comprise further user parameter values or other data describing the user that may be used by the vector engine 122 to generate a targeting vector to provide to an advertising platform. Accordingly, the vector engine 122 is configured in at least some embodiments to combine the intermediate targeting vectors to generate a targeting vector (e.g., the vector (X, Y, Z)) to provide to an advertising platform. The vector engine 122 may perform this combination by summing the intermediate targeting vectors, calculating a dot product of the intermediate targeting vectors, and/or other means that may be used to combine the intermediate targeting vectors. The vector engine 122 may be further configured to apply a weight to one or more of the intermediate targeting vectors prior to combining the intermediate targeting vectors.

Once the vector engine 122 has generated the targeting vector to be provided to the advertising platform, the vector engine 122 is configured to provide the targeting vector to the advertising platform. In this regard, an advertising platform comprises a unit configured to receive a targeting vector and select one or more advertisements to be presented to the user based at least in part upon the targeting vector. These selected advertisements are deemed to be of interest to the user as indicated at least in part by the targeting vector. In an exemplary embodiment, the advertising platform is embodied on the advertising server 104. Accordingly, in such embodiments, the vector engine 122 is configured to send the generated targeting vector to the advertising server 104. In other embodiments, however, the advertising platform may be embodied on the user device 102. In this regard, the user device 102 may receive an advertising platform and a plurality of advertisements and/or advertising campaign from the advertising server 104 and actual selection of advertisements and/or advertising campaigns based on the generated targeting vector may occur at the user device 102. Accordingly, the vector engine 122 is configured in such embodiments to provide the targeting vector to the local advertising platform.

The vector engine 122 may then receive one or more advertisements selected based at least in part upon the provided targeting vector from the advertising platform. The vector engine 122 may be configured to present the one or more received advertisements to the user, such as by rendering the advertisements on a display embodied on or connected to the user interface 116. In some embodiments, the vector engine 122 may not directly render the advertisements on the display or otherwise directly present the advertisements to the user, but may instead indirectly present the advertisements to the user, such as by providing the advertisements to an application, such as a web browser, responsible for rendering the advertisements. In at least some embodiments, the vector engine 122 is further configured to monitor the user's interaction with the received advertisements to determine an effectiveness level of the received advertisements. In this regard, the vector engine 122 may be configured to determine a rate at which the user positively interacts with the received advertisements, such as by clicking on the advertisements. This rate may be referred to as a “click through rate.” The vector engine 122 may be further configured to determine which advertisements and/or advertising campaigns that the user positively interacts with.

The vector engine 122 may receive a target effectiveness level (e.g., a target click through rate) from the advertising platform in association with one or more advertisements and/or an advertising campaign. This target effectiveness level may comprise a predefined target effectiveness level or may comprise an aggregate mean effectiveness level determined by the advertising platform or advertising server 104 across users of multiple user devices 102 receiving advertisements from the advertising server 104. After a period of monitoring the user's interaction with received advertisements (e.g., after a period of time and/or after a predefined number of advertisements have been presented to the user) the vector engine 122 is configured in at least some embodiments to compare the determined effectiveness level to the target effectiveness level. If the determined effectiveness level is less than the target effectiveness level, the vector engine 122 may update the targeting vector by modifying the targeting vector to enhance the effectiveness level of advertisements selected based at least in part upon the targeting vector. It will be appreciated, however, that the vector engine 122 may update the targeting vector even when the determined effectiveness level meets or exceeds the target effectiveness level by fine tuning the targeting vector using any of the various methods for updating the targeting vector. The vector engine 122 may then provide the updated targeting vector to the advertising platform to permit future received advertisements to be selected based at least in part upon the updated targeting vector.

In exemplary embodiments, the vector engine 122 is configured to implement a feedback loop such that the targeting vector is periodically updated, such as when the determined effectiveness level is less than the target effectiveness level. In this regard, the vector engine 122 may monitor the user's interaction with received advertisements for a period of time and/or for a predefined number of advertisements following the generation of each targeting vector to determine an effectiveness level of advertisements selected based at least in part upon the most recent targeting vector. The vector engine 122 may then update the targeting vector, provide the most recent targeting vector to the advertising platform and begin the monitoring and updating process anew. Accordingly, the most recent targeting vector is provided to the advertising platform to enable the advertising platform to select advertisements and/or advertising campaigns that may be of interest to the user based at least in part upon the most recent targeting vector. In this regard, only a single targeting vector may be used at any given time for selection of advertisements and/or advertising campaigns. Thus each updated targeting vector generated by the vector engine 122 replaces the previously generated targeting vector.

The vector engine 122 may be configured to update the targeting vector in any number of ways, such as, for example, by changing the user parameters and/or weighting thereof used to generate the targeting vector, changing the weights applied to intermediate targeting vectors when generating the targeting vector, biasing the targeting vector toward a vector area wherein advertisements that the user has positively interacted with lie, biasing the targeting vector away from a vector area wherein advertisements that the user has not positively interacted with lie, and/or the like. Further, the targeting vector may be updated and refined as additional user data is collected by the datapoint engine 118. In this regard, the vector engine 122 may be configured to update the targeting vector by utilizing updated user parameters provided by the ad parameter engine 120 (e.g., updated ad parameters determined in response to collection of additional data and determination of updated user profile data points by the datapoint engine 118).

In some embodiments, the vector engine 122 may receive, from the advertising platform, an advertisement target vector with an advertising campaign or advertisement. The advertisement target vector may comprise a vector indicating a profile of a user which the advertisement or advertising campaign is intended to interest. The advertisement target vector may alternatively indicate a profile of the average user that has previously positively interacted with the advertisement (e.g., as may be determined by the advertising server 104 and/or advertising platform through monitoring and aggregating the interactions of a plurality of users of user devices 102 on the system 100 with the advertisement). Accordingly, in at least some embodiments, the vector engine 122 is configured to update the targeting vector by biasing the targeting vector toward the area where advertisement target vectors associated with advertisements that the user has positively interacted with (e.g., advertisements that the user has clicked on) are located. Further, in at least some embodiments, the vector engine 122 is configured to update the targeting vector by biasing the targeting vector away from an area where advertisement target vectors associated with advertisements that the user has not positively interacted with (e.g., advertisements that the user has not clicked on) are located.

Additionally or alternatively, the vector engine 122 may be configured to adjust the weights applied to intermediate targeting vectors and/or to user parameters used to generate a targeting vector and/or intermediate targeting vector such that the values of the updated targeting vector are adjusted. In some embodiments, the vector engine 122 may additionally or alternatively be configured to generate a feedback vector (e.g., (X_{F}, Y_{F}, Z_{F})), which may be used as an intermediate targeting vector used in the generation of the updated targeting vector. In this regard, the feedback vector may be combined with other intermediate vectors to generate the targeting vector (e.g., by summing the intermediate targeting vectors with the feedback vector, calculating the dot product of the feedback vector and intermediate targeting vectors, and/or the like).

In some embodiments, the vector engine 122 may be configured to determine which method of updating the feedback to use based at least in part upon the user's previous interaction with advertisements. For example, if the vector engine 122 has determined that the user has positively interacted with more than a predefined number of advertisements, the vector engine 122 may be configured to update the targeting vector by biasing the targeting vector toward the area where advertisement target vectors associated with advertisements that the user has positively interacted with (e.g., advertisements that the user has clicked on) are located. If the user has positively interacted with less than a predefined number of advertisements, the vector engine 122 may be configured to adjust weightings of the intermediate targeting vectors and/or of user parameters, as there may not be a sufficient number of (or any) advertisement target vectors which the vector engine 122 may bias the targeting vector toward to generate a more accurate targeting vector. In this regard, the vector engine 122 may select a method to update the targeting vector based on a reliability policy. If the user has only clicked on one advertisement, the clicked on advertisement may be an outlier and biasing the targeting vector toward the advertisement target vector associated with that advertisement may result an a less accurate targeting vector that may be less effective than the previous targeting vector. However, if the user has clicked on several advertisements having advertisement target vectors in close proximity to each other, then biasing the targeting vector toward the area of those advertisement target vectors may result in a more accurate targeting vector that is more effective than the previous targeting vector.

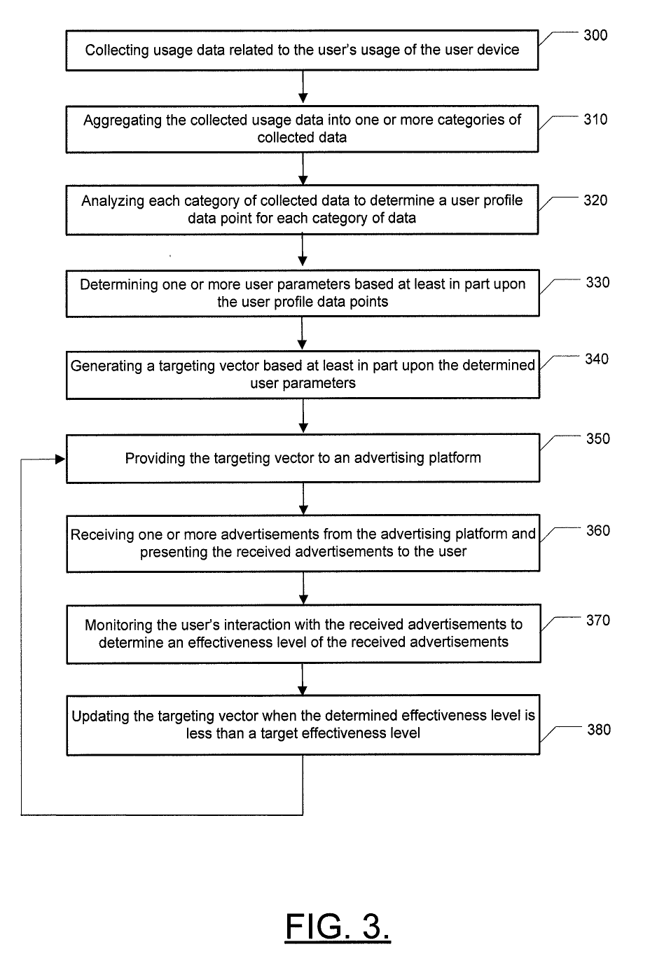

FIG. 3 is a flowchart of a system, method, and computer program product according to exemplary embodiments of the invention. It will be understood that each block or step of the flowchart, and combinations of blocks in the flowchart, may be implemented by various means, such as hardware, firmware, and/or software including one or more computer program instructions. For example, one or more of the procedures described herein may be embodied by computer program instructions. In this regard, the computer program instructions which embody the procedures described above may be stored by a memory device of a mobile terminal, server, or other computing device and executed by a processor in the computing device. In some embodiments, the computer program instructions which embody the procedures described above may be stored by memory devices of a plurality of computing devices. As will be appreciated, any such computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer instructions.

In this regard, one exemplary method for providing targeted advertising according to an exemplary embodiment of the present invention is illustrated in FIG. 3. The method comprises the datapoint engine 118 collecting usage data related to the user's usage of the user device 102, at operation 300. Operation 310 comprises the datapoint engine 118 aggregating the collected usage data into one or more categories of collected data. Operation 320 comprises the datapoint engine 118 analyzing each category of collected data to determine a profile data point for each category. Operation 330 comprises the ad parameter engine 120 determining one or more user parameters based at least in part upon the profile data points. Operation 340 comprises the vector engine 122 generating a targeting vector based at least in part upon the determined user parameters. Operation 350 comprises the vector engine 122 providing the targeting vector to the advertising platform to permit the advertising platform to select one or more advertisements based at least in part upon the provided targeting vector. Operation 360 comprises the vector engine 122 receiving one or more advertisements from the advertising platform and presenting the received advertisements to the user. Operation 370 comprises the vector engine 122 monitoring the user's interaction with the received advertisements to determine an effectiveness level of the received advertisements, and by proxy, an effectiveness level of the targeting vector. Operation 380 comprises the vector engine 122 periodically updating the targeting vector when the determined effectiveness level is less than a target effectiveness level. The vector engine 122 may then provide the updated targeting vector to the advertising platform at operation 350, such that the vector engine 122 implements a feedback loop.

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to advertisers, content providers, and computing device users. Embodiments of the invention provide enhanced targeted advertising such that a targeting vector used to select advertisements to present to a user is periodically updated based on a feedback loop as more data about the user's behavior and interactions with previously presented advertisements is collected. Embodiments of the invention locally collect data and generate the targeting vector such that targeted advertising may be provided to a user by an advertising server even if the user is not previously known to the advertising server. Further, by locally collecting the user data and generating the targeting vector, users may benefit from reduced risk of sensitive data being compromised.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising a processor configured to:
determine one or more user parameters, each user parameter defining an attribute of a user of the apparatus, wherein the processor is configured to determine each user parameter based at least in part upon locally collected user data;
generate a targeting vector based at least in part upon the one or more determined user parameters;
provide the targeting vector to an advertising platform to permit one or more advertisements to be selected based at least in part upon the provided targeting vector;
receive the one or more advertisements from the advertising platform;
present the one or more received advertisements to the user;
monitor the user's interaction with the received one or more advertisements to determine an effectiveness level of the one or more received advertisements; and
update the targeting vector when the determined effectiveness level is less than a target effectiveness level by modifying the targeting vector to enhance the effectiveness level of advertisements selected based at least in part upon the targeting vector, the processor configured to provide the updated targeting vector to the advertising platform to permit future received advertisements to be selected based at least in part upon the updated targeting vector.

2. An apparatus according to claim 1, wherein the processor is configured to implement a feedback loop such that the targeting vector is periodically updated when the effectiveness level of the received one or more advertisements is less than the target effectiveness level by modifying the targeting vector to enhance the effectiveness level of advertisements selected based at least in part upon the targeting vector and to provide each updated targeting vector to the advertising platform such that future received advertisements are selected based at least in part upon the most recent updated targeting vector.

3. An apparatus according to claim 1, wherein the processor is further configured to receive a first intermediate targeting vector describing one or more attributes of the user from a remote computing device; and wherein the processor is configured to generate the targeting vector by:
generating a second intermediate targeting vector based at least in part upon the one or more determined user parameters; and
combining the first and second intermediate targeting vectors to generate the targeting vector.

4. An apparatus according to claim 3, wherein the processor is configured to:
combine the first and second intermediate targeting vectors by applying a first weight to the first intermediate targeting vector and a second weight to the second intermediate targeting vector and summing the weighted first and second intermediate targeting vectors; and
wherein the processor is configured to update the targeting vector by adjusting at least one of the first weight applied to the first intermediate targeting vector or the second weight applied to the second intermediate targeting vector and re-summing the weighted first and second intermediate targeting vectors.

5. An apparatus according to claim 1, wherein the processor is further configured to:
receive, from the advertising platform, one or more advertisement target vectors, wherein each advertisement target vector corresponds with at least one received advertisement; and
monitor the user's interaction with the received one or more advertisements to determine advertisements with which the user has positively interacted; and
wherein the processor is configured to update the targeting vector when the determined effectiveness level is less than the target effectiveness level by biasing the targeting vector toward an area where one or more advertisement targeting vectors corresponding to the determined advertisements are located.

6. An apparatus according to claim 1, wherein the processor is further configured to:
collect usage data related to the user's usage of the apparatus;
aggregate the collected usage data into one or more categories of collected data; and
analyze each category of collected data to determine a user profile data point for each category of data; and
wherein the processor is configured to determine each user parameter based at least in part upon one or more determined user profile data points.

7. An apparatus according to claim 1, wherein the processor is configured to:
monitor the user's interactions by monitoring whether the user clicks through any of the advertisements to determine the user's click through rate; and
update the targeting vector when the determined click through rate is less than a target click through rate.

8. An apparatus according to claim 1, further comprising a display in communication with the processor; wherein the processor is further configured to present the one or more received advertisements to the user by rendering the received one or more advertisements on the display.

9. A computer program product comprising at least one computer-readable storage medium having computer-readable program instructions stored therein, the computer-readable program instructions comprising:
a program instruction for determining one or more user parameters, wherein each user parameter defines an attribute of a user and is determined based at least in part upon locally collected user data;
a program instruction for generating a targeting vector based at least in part upon the one or more determined user parameters;
a program instruction for providing the targeting vector to an advertising platform to permit one or more advertisements to be selected based at least in part upon the provided targeting vector;
a program instruction for receiving the one or more advertisements from the advertising platform;
a program instruction for presenting the one or more received advertisements to the user;
a program instruction for monitoring the user's interaction with the received one or more advertisements to determine an effectiveness level of the one or more received advertisements;
a program instruction for updating the targeting vector when the determined effectiveness level is less than a target effectiveness level by modifying the targeting vector to enhance the effectiveness level of advertisements selected based at least in part upon the targeting vector; and
a program instruction for providing the updated targeting vector to the advertising platform to permit future received advertisements to be selected based at least in part upon the updated targeting vector.

10. A computer program product according to claim 9, further comprising:
a program instruction for implementing a feedback loop such that the targeting vector is periodically updated when the effectiveness level of the received one or more advertisements is less than the target effectiveness level by modifying the targeting vector to enhance the effectiveness level of advertisements selected based at least in part upon the targeting vector and for providing each updated targeting vector to the advertising platform such that future received advertisements are selected based at least in part upon the most recent updated targeting vector.

11. A computer program product according to claim 9, further comprising a program instruction for receiving a first intermediate targeting vector describing one or more attributes of the user from a remote computing device; and wherein the program instruction for generating a targeting vector comprises instructions for generating the targeting vector by:
generating a second intermediate targeting vector based at least in part upon the one or more determined user parameters; and
combining the first and second intermediate targeting vectors to generate the targeting vector.

12. A computer program product according to claim 11, wherein the program instruction for generating a targeting vector comprises instructions for combining the first and second intermediate targeting vectors by applying a first weight to the first intermediate targeting vector and a second weight to the second intermediate targeting vector and summing the weighted first and second intermediate targeting vectors; and
wherein the program instruction for updating the targeting vector comprises instructions for updating the targeting vector by adjusting at least one of the first weight applied to the first intermediate targeting vector or the second weight applied to the second intermediate targeting vector and re-summing the weighted first and second intermediate targeting vectors.

13. A computer program product according to claim 9, further comprising:
a program instruction for receiving, from the advertising platform, one or more advertisement target vectors, wherein each advertisement target vector corresponds with at least one received advertisement; and
a program instruction for monitoring the user's interaction with the received one or more advertisements to determine advertisements with which the user has positively interacted; and
wherein the program instruction for updating the targeting vector includes instructions for updating the targeting vector when the determined effectiveness level is less than the target effectiveness level by biasing the targeting vector toward an area where one or more advertisement targeting vectors corresponding to the determined advertisements are located.

14. A computer program product according to claim 9, further comprising:
a program instruction for collecting usage data related to the user's usage of a computing device;
a program instruction for aggregating the collected usage data into one or more categories of collected data; and
a program instruction for analyzing each category of collected data to determine a user profile data point for each category of data; and
wherein the program instruction for determining one or more user parameters includes instructions for determining each user parameter based at least in part upon one or more determined user profile data points.

15. A method comprising:
determining one or more user parameters, wherein each user parameter defines an attribute of a user of a computing device and is determined based at least in part upon locally collected user data;
generating, with a processor embodied in the computing device, a targeting vector based at least in part upon the one or more determined user parameters;
providing the targeting vector to an advertising platform to permit one or more advertisements to be selected based at least in part upon the provided targeting vector;
receiving the one or more advertisements from the advertising platform;
presenting the one or more received advertisements to the user;
monitoring the user's interaction with the received one or more advertisements to determine an effectiveness level of the one or more received advertisements;
updating the targeting vector when the determined effectiveness level is less than a target effectiveness level by modifying the targeting vector to enhance the effectiveness level of advertisements selected based at least in part upon the targeting vector; and
providing the updated targeting vector to the advertising platform to permit future received advertisements to be selected based at least in part upon the updated targeting vector.

16. A method according to claim 15, further comprising:
implementing a feedback loop such that the targeting vector is periodically updated when the effectiveness level of the received one or more advertisements is less than the target effectiveness level by modifying the targeting vector to enhance the effectiveness level of advertisements selected based at least in part upon the targeting vector and providing each updated targeting vector to the advertising platform such that future received advertisements are selected based at least in part upon the most recent updated targeting vector.

17. A method according to claim 15, further comprising receiving a first intermediate targeting vector describing one or more attributes of the user from a remote computing device; and wherein generating a targeting vector comprises generating the targeting vector by:
generating a second intermediate targeting vector based at least in part upon the one or more determined user parameters; and
combining the first and second intermediate targeting vectors to generate the targeting vector.

18. A method according to claim 17, wherein combining the first and second intermediate targeting vectors comprises combining the first and second intermediate targeting vectors by applying a first weight to the first intermediate targeting vector and a second weight to the second intermediate targeting vector and summing the weighted first and second intermediate targeting vectors; and
wherein updating the targeting vector comprises updating the targeting vector by adjusting at least one of the first weight applied to the first intermediate targeting vector or the second weight applied to the second intermediate targeting vector and re-summing the weighted first and second intermediate targeting vectors.

19. A method according to claim 15, further comprising:
receiving, from the advertising platform, one or more advertisement target vectors, wherein each advertisement target vector corresponds with at least one received advertisement; and
monitoring the user's interaction with the received one or more advertisements to determine advertisements with which the user has positively interacted; and
wherein updating the targeting vector comprises updating the targeting vector when the determined effectiveness level is less than the target effectiveness level by biasing the targeting vector toward an area where one or more advertisement targeting vectors corresponding to the determined advertisements are located.

20. A method according to claim 15, further comprising:
collecting usage data related to the user's usage of the computing device;
aggregating the collected usage data into one or more categories of collected data; and
analyzing each category of collected data to determine a user profile data point for each category of data; and
wherein determining one or more user parameters comprises determining each user parameter based at least in part upon one or more determined user profile data points.
